(19) United States
(12) Patent Application Publication
(10) Pub. No.: US 2006/0195435 A1
(43) Pub. Date: Aug. 31, 2006

(54) System and method for providing query assistance

(75) Inventors: Thomas M. Laird-McConnell, Bellevue, WA (US); Steven Wayne Ickman, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/066,157

(22) Filed: Feb. 28, 2005

(51) Int. Cl. G06F 17/30

(52) U.S. Cl. 707/4

(57) ABSTRACT

A system and method provide real time query assistance from a search engine to a user formulating a query. The system may include stored corpus information that provides a detailed description of a corpus, a user input detection component for incrementally detecting user input and a corpus search component for searching the corpus upon detection of each increment in order to provide query completion options. The system may further include a user interaction component for providing the user with selectable options after each detection cycle.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to a system and method for providing query assistance and in particular a system and method for providing query assistance based on information contained within a corpus. ding improved visual feedback.

### BACKGROUND OF THE INVENTION

Through the Internet and other networks, users have gained access to large amounts of information distributed over a large number of computers. In order to access the vast amounts of information, users typically implement a user browser to access a search engine. The search engine responds to an input user query by returning one or more sources of information available over the Internet or other network.

In operation, the search engine typically implements a crawler to access a plurality of information sources and stores references to those information sources in an index. The references in the index may be categorized based on one or more keywords.

Traditional search engines provide a simple text entry box that allows users to enter search terms or keywords. The search engine then surfaces every document that contains the entered terms by traversing the index in order to locate the input query terms. However, in many instances, the terms in the index may not correspond to the input query terms and the search engine produces minimal or inadequate results. This may occur for several reasons. The desired information may be indexed based on synonymous terms, alternative combinations of keywords, or words with slight spelling variations. Either the words in the user query or the words in the documents may be misspelled. Thus, in order to receive desired search results, users may implement a trial and error technique and enter terms several times before receiving acceptable results or any results.

After a search is entered, an existing search engine may search the index based on typed words and if finds no matches in the index, the search engine returns a page with no results. If a word is misspelled, part of the return page may show an alternate spelling. Some existing search engines will attempt spelling corrections and reissue the search. However, if users want to search for variations of the entered terms, the users are typically required to repeat the search with different input terms.

A further disadvantage of existing search systems is that user must completely enter and submit search terms before learning that no results exist. In reality, after a portion of the query is typed in, the search engine may already be able to determine that no results exist in the index.

Accordingly, a solution is needed that provides guidance to a user as a new search term is being typed. An interactive user interface that assists users in formulating successful queries would allow users to more quickly enter effective queries.

### BRIEF SUMMARY OF THE INVENTION

Embodiments of the present invention include a method for providing real time query assistance to a user formulating a query. The method may include incrementally detecting user input and searching corpus information upon detection of each increment. The method may additionally comprise presenting a user interface to the user after each corpus information search, the user interface including at least one query completion option.

In additional aspects, a system for providing real time query assistance from a search engine to a user formulating a query is provided. The system may include stored corpus information that provides a detailed description of a corpus and a user input detection component for incrementally detecting user input. The system may additionally include a corpus search component for searching the corpus upon detection of each increment in order to provide query completion options.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is block diagram illustrating a computerized environment in which embodiments of the invention may be implemented;

FIG. 3 is a block diagram illustrating query assistance components in accordance with an embodiment of the invention;

FIG. 4 is a screen shot illustrating a user interface provided by the query assistance components in accordance with an alternative embodiment of the invention;

FIG. 5 is a screen shot illustrating an additional user interface in accordance with an embodiment of the invention; and

FIG. 6 is a flow chart illustrating a method for providing user query assistance in accordance with an embodiment of the invention.

### DETAILED DESCRIPTION OF THE INVENTION

I. System Overview

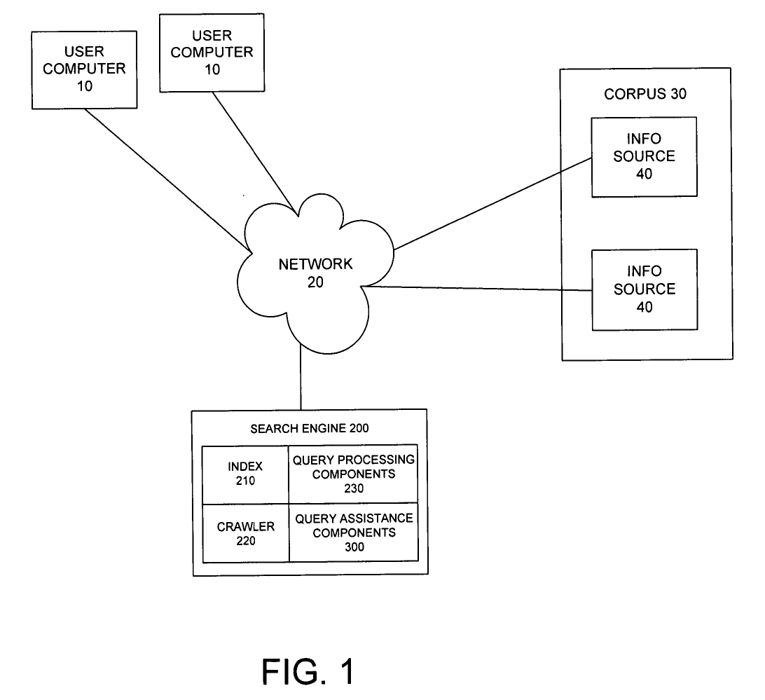

Embodiments of the invention provide a method and system for providing interactive query assistance to a user seeking information from a search engine. FIG. 1 illustrates a system for providing query assistance in accordance with an embodiment of the invention. The system may include a plurality of user computers 10 connected over a network 20 with a search engine 200. The search engine 200 may respond to a user query by searching a corpus 30 containing multiple information sources 40 such as documents.

The search engine 200 may include an index 210, a crawler 220 for building the index 210, query processing components 230, and query assistance components 300. The index 210 includes information including each word contained in the corpus and statistical information regarding the words contained in the corpus. The search engine 200 may include additional known components, omitted for simplicity.

As a user types a query, the query assistance components 300 may analyze the query in real time prior to its completion and provide query assistance as necessary in order to facilitate completion of a query. The query assistance components 300 may provide partial matches to a new search term as it is being typed with matches of words from the corpus. Thus, the query assistance components 300 allow users to more quickly enter queries by displaying a list of terms and allowing the user to select the correct term when it is displayed. Furthermore, the query assistance components 300 may display phonetic matches, thereby allowing the user more flexibility in creating the search request. In additional embodiments, the query assistance components 300 may conduct natural language parsing to analyze a query to provide partial matches based on the content of the query.

II. Exemplary Operating Environment

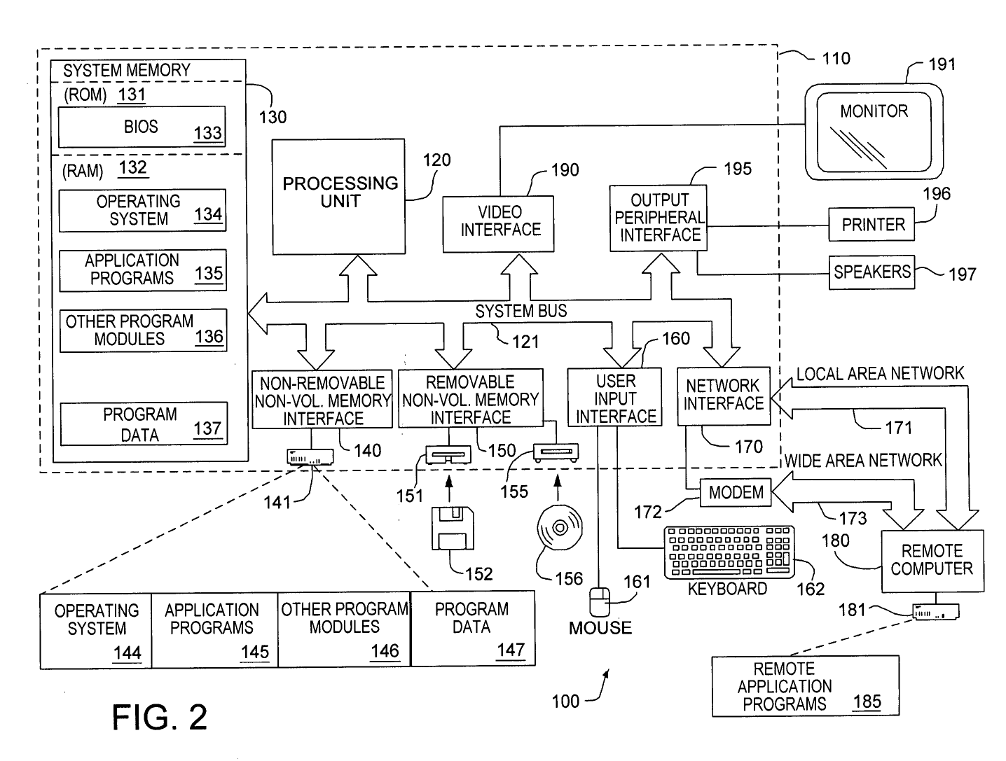

FIG. 2 illustrates an example of a suitable computing system environment 100 on which the system for providing query assistance may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 1 illustrates a system for providing query assistance in accordance with an embodiment of the invention. The system may include user computers 10 connected over the network 20 with the search engine 200. As described above with respect to FIG. 2, the network 20 may be one of any number of different types of networks.

The search engine 200 may respond to a user query by searching the corpus 30 containing multiple information sources 40 such as documents. The crawler 220 may build the index 210 with all of the words contained within the corpus 30. The index 210 may also include statistical information regarding the frequency and distribution of words in the corpus 30. Language based word-breakers may be used to determine what constitutes a term in the text stream. Query processing components 230 may process queries upon entry and query assistance components 300 may process each letter or segment of a query in order to provide assistance. The search engine 200 may include additional known components, omitted for simplicity.

Since the index 210 includes ample information from the corpus 30, the query assistance components 300 can query the index 210 to obtain partial matches based on the user input. The query assistance components 300 may also query the index 210 for statistical information such as document sizes and word frequency.

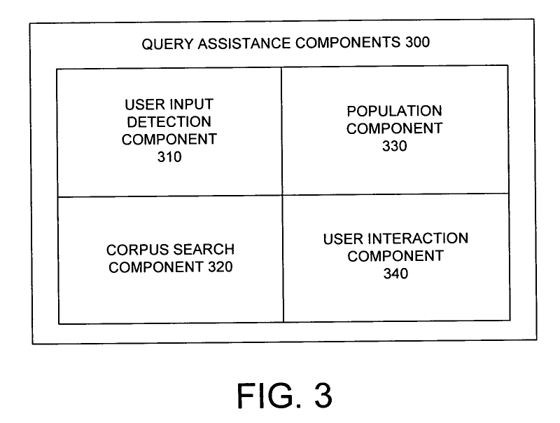

FIG. 3 is a block diagram illustrating query assistance components 300 in accordance with an embodiment of the invention. The query assistance components 300 may include a user input detection component 310, a corpus search component 320, a population component 330, and a user interaction component 340. The user input detection component 310 may detect each piece of user input in real time. In other words, the user input detection component 310 detects typing in real time, prior to a user selecting an “enter” or “submit” option. The corpus search component 320 is then able to search the corpus or an index of terms in the corpus or including information from the corpus based on the detected input. The population component 330 selects a number of possible matching queries from the corpus based on the search. Finally, the user interaction component 340 presents the query options in a selectable format to the user.

The user interaction component 340 responds to the results of the corpus search component 320, which incrementally searches results as the user types. In embodiments of the invention, the population component 330 populates a drop-down list with the terms that start with the letters of the current term. The user interaction component 340 may provide several modes of interaction with the located terms. For example, the user interaction component 340 could allow the user to interact with the populated list of terms by allowing a tab key to automatically complete the selected word. Alternatively, a shift key and down arrow may allow the user to select multiple words. As a further option, the user interaction components may add a hot key to toggle if the system shows sounds-like phonetic variations.

Specifically, in situations in which the corpus is small or unique enough, the query assistance components 300 can mine the data in the corpus itself to drive the user interface and enhance relevance and the search experience. In embodiments of the invention, the user interface may give feedback to the user, as the user types, based on the information available in the corpus. This leads to the user modifying the search in real-time with the results that are provided by the query assistance components 300.

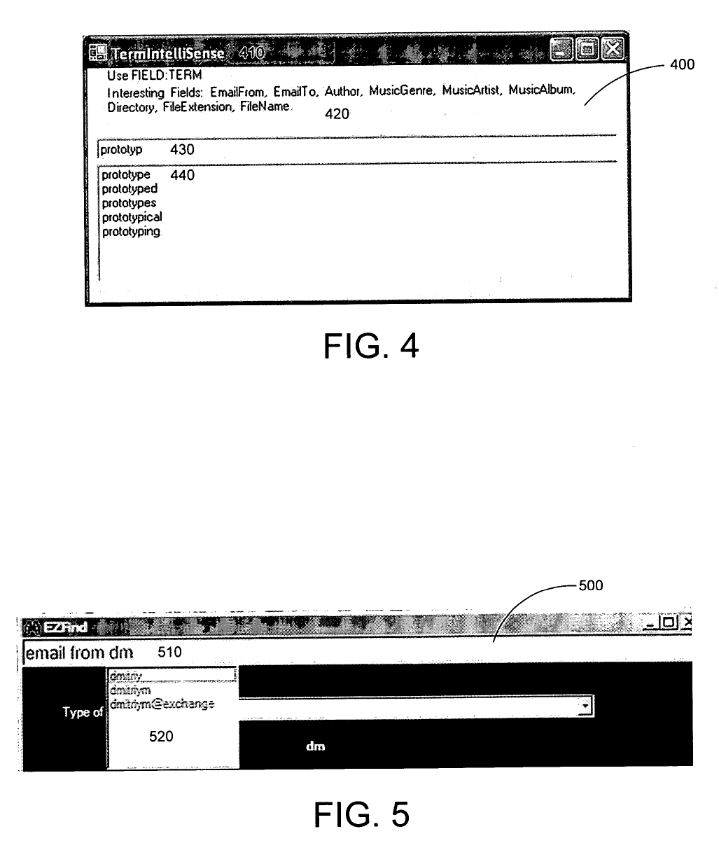

FIG. 4 is a screen shot illustrating a user interface 400 in accordance with an embodiment of the invention. The user interface 400 may include a selection of user fields 410. A set of options 240 may include “emailfrom”, “emailto”, “author”, “musicgenre”, “musicartist”, “musicalbum”, “directory”, “fileextension”, and “filename”. The user interface 400 may additionally include a text entry box 430 for allowing user input and a dropdown menu 440 for providing real time completions of the user query in text entry box 430. The user interface 400 changes as the user types in real time to provide a feedback mechanism and allow enhanced user accuracy. The user interaction component 340 may modify list of suggestions based on previous words and the corpus 30.

FIG. 5 is a screen shot illustrating a user interface 500 in accordance with an embodiment of the invention. The user interface 500 may include an input box 510 in which the user is searching for an “email from dm”. A menu 520 of completion options may be provided in real time. As soon as the user types “dm”, the provided menu 520 includes “dmitriy”, “dmitriym”, and “dmitriym@exchange”.

As set forth above, the user interaction component 340 may provide several mechanisms for assisting a user. The user interaction component 340 may provide a user interface that prompts the user with a list of partial matches. Alternatively, the user interaction component 340 may use semantic or natural-language analysis to restrict the user interface. For example, as shown in FIG. 5 “email from dm” could be analyzed as a query and the user interface may only show terms that start with DM in the FROM field (as opposed to showing all terms in any field in the corpus that start with DM).

A further option may include allowing multiple options to be selected and added to the query. For example, in response to the input letters “cas”, the user interface may show the options: “catastrophy”, “castophy”, and “cast”. The user may be allowed to select any number of the provided choices. The user interaction component 340 may additionally use phonetic spelling matches to show the list of possible term matches. For example, with the input letters “cat”, the user interaction component 340 may show “cat”, “kat”, “catastrophe”, and “catastrophy” as possible term matches. The user interaction component 340 may additionally use statistical information in the corpus to rank and/or restrict the terms which the user is prompted with or provide like synonyms based on the values in the corpus.

An example of the operation of the above-described system is illustrated below. The user is looking for a document written by Dmitriy, but the user doesn't know the correct spelling. In a conventional search engine, the user might type in “Dmitry” (missing the ‘i’ between the t and y) and, assuming the documents in the corpus correctly have ‘Dmitriy” in them, the search engine would return zero results. With the above-described system, as the user types the letters, the user interaction component 340 may prompt the user with terms from the corpus that match the letters the user has have typed so far. Table 1 below illustrates the described scenario.

TABLE 1

| | | Matching Results |
|---|---|---|
| User Types | Matching terms displayed | Displayed |
| D | Dad | All documents with |
| | Date | terms starting with D |
| | Dare | |
| | Dark | |
| | Dmitriy | |
| | Dmitrey | |
| | do | |
| | dog | |
| | etc.. | |
| Dm | Dmitriy | All documents with |
| | Dmitrey ( [symbol] document may have | terms start with Dm |
| | misspelling in it) | |

As illustrated above, once the user typed in two letters “Dm”, the user interaction component 340 presented the user with the single correct result based on the contents of the corpus. In a conventional system, the user would have been required to type the entire query. If the user had misspelled the query, the search engine 200 would not have provided any results. In order to provide the results, the search engine may access the index 210 or other available resources such as a dictionary or thesaurus. Furthermore, resources such as a dictionary and thesaurus may be contained within the index 210. The system may also access statistical information in the index 210 regarding frequency of words or co-occurrence of terms. Regarding frequency, selected ranges of frequencies are often useful predictors. If a word appears in every document or in the vast majority of documents, that word is typically not a good predictor. Co-occurrence of terms or the appearance of word pairs can also provide meaningful assistance for obtaining results.

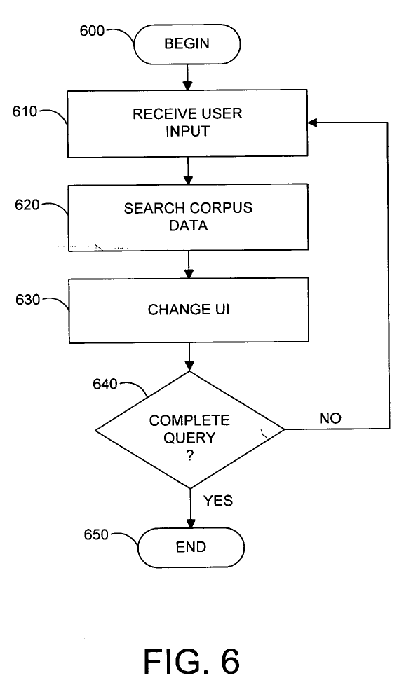

FIG. 6 illustrates a method for providing user assistance in accordance with an embodiment of the invention. The method begins in step 600 in response to the user providing some action in the user interface, such as typing on new letter. The query assistance components detect user input in step 610. In response to the detection, the query assistance components 300 search corpus data in step 620. Based on the located corpus data, the query assistance components 300 change the user interface in step 630. If the query is completed in step 640, the process ends in step 650. Otherwise, the query assistance components 300 return to step 610 and the detection of user input.

Each time the user types in a new character, the process described above repeats itself in real-time. The system aims to keep up with the user by querying the list of matching terms as fast as the user types. Although the system and method described above are shown in connection with a network, it is also possible to use the system and method in connection with a desktop search. In this instance, the system is able show the results even more quickly. The system of the invention is particularly useful in small domains that contain useful predictors.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for providing real time query assistance to a user formulating a query for searching a corpus, the method comprising:
incrementally detecting user input;
searching corpus information upon detection of each increment; and
presenting a user interface to the user after each corpus information search, the user interface including at least one query completion option.

2. The method of claim 1, further comprising presenting the user with a drop down menu of selectable query completion options.

3. The method of claim 1, further comprising searching corpus information for phonetic matches.

4. The method of claim 1, wherein each increment comprises a typed letter.

5. The method of claim 1, further comprising providing a drop down menu that allows a user to select more than one option.

6. The method of claim 1, further comprising implementing natural language parsing to parse the query.

7. The method of claim 1, further comprising searching the corpus information for synonyms.

8. The method of claim 1, further comprising repeatedly searching the corpus information after each increment until the user enters the query.

9. A system for providing real time query assistance from a search engine to a user formulating a query, the system comprising:
stored corpus information that provides a detailed description of a corpus;
a user input detection component for incrementally detecting user input; and
a corpus search component for searching the corpus upon detection of each increment in order to provide query completion options.

10. The system of claim 9, further comprising a population component for populating a drop down menu including query completion options.

11. The system of claim 10, further comprising a user interaction component for facilitating user interaction with the query completion options.

12. The system of claim 9, wherein the corpus search component comprises means for searching corpus information for phonetic matches.

13. The system of claim 9, wherein the user detection component detects each letter typed by the user.

14. The system of claim 9, wherein the user input detection component implements natural language parsing to parse the query.

15. The system of claim 9, wherein the corpus search component further searches the corpus information for synonyms.

16. A computer readable medium storing computer executable instructions for providing real time query assistance to a user formulating a query, comprising:
incrementally detecting user input;
searching corpus information upon detection of each increment; and
presenting a user interface to the user after each corpus information search, the user interface including at least one query completion option.

17. The computer readable medium of claim 16, further comprising an instruction for presenting the user with a drop down menu of selectable query completion options.

18. The computer readable medium of claim 16, further comprising an instruction for searching corpus information for phonetic matches.

19. The computer readable medium of claim 16, further comprising an instruction for recognizing each typed letter as an increment.

20. The computer readable medium of claim 16, further comprising an instruction for providing a drop down menu that allows a user to select more than one option.
